(19) United States
(12) Patent Application Publication
(10) Pub. No.: US 2024/0008492 A1
(43) Pub. Date: Jan. 11, 2024

(54) COMPOSITION AND METHODS FOR MANAGING AND CONTROLLING HEMIPTERA INSECTS

(71) Applicant: ISCA Technologies, Inc., Riverside, CA (US)

(72) Inventors: Agenor Mafra-Neto, Riverside, CA (US); Rafael Borges, Fraiburgo (BR)

(21) Appl. No.: 18/347,965

(22) Filed: Jul. 6, 2023

Related U.S. Application Data
(60) Provisional application No. 63/367,943, filed on Jul. 8, 2022.

(51) Int. Cl. A01N 53/00; A01N 43/20; A01N 37/08; A01P 19/00; A01N 43/88; A01N 43/56; A01N 43/50; A01P 7/04

(52) U.S. Cl. CPC A01N 53/00; A01N 43/20; A01N 37/08; A01P 19/00; A01N 43/88; A01N 43/56; A01N 43/50; A01P 7/04

(57) ABSTRACT

Compositions and methods of using the compositions for controlling a hemiptera population, wherein the compositions contain at least one at least one aggregation pheromone and at least one kairomone attractant. The compositions may further include a pesticide.

### CROSS-REFERENCE TO RELATED APPLICATIONS

This application claims the benefit of U.S. Provisional Patent Application No. 63/367,943, filed on Jul. 8, 2022, the teachings of which are expressly incorporated by reference.

### STATEMENT RE: FEDERALLY SPONSORED RESEARCH/DEVELOPMENT

NOT APPLICABLE

### BACKGROUND

The present disclosure relates generally to compositions and methods for protecting row crops from hemiptera pests, and more particularly to attract-and-kill (A&K) formulations for stink bugs. In general, stink bugs are a group of insects that include multiple widespread and highly polyphagous crop pests. Brown marmorated stink bug, Halymorpha halys, for example, has a host range of >100 plants, including fruit crops, row crops, vegetables, forest trees, and ornamentals. In 2010, when H. halys populations spiked in the mid-Atlantic US, apple growers suffered crop losses of >$37 million. In addition to agricultural impacts, H. halys is also a seasonal nuisance pest in many temperate regions, as it tends to seek shelter in winter within human-made structures (homes, offices, attics, vehicles) rather than in natural environments. The insects can then emerge en masse as the weather warms, staining walls, floors, and other surfaces with their excrement and discharging a persistent, foul-smelling liquid when disturbed. Broad-spectrum pesticides are the most common method of control for stink bug pests in agriculture, but this approach has been shown to have major shortcomings. The toxic mode of action of most of these chemicals makes them a threat to human health as well as to other nontarget species, especially beneficial insects such as honeybees and other pollinators. Conventional insecticides have also repeatedly proven susceptible to the development of resistance, the gradual buildup of tolerance to a given chemical in a target pest population, eventually resulting in its loss of efficacy as a control agent.

The complex of insects known as stink bugs (Hemiptera: Pentatomidae), named for the pungent odor of the defensive spray they release if disturbed, includes multiple serious and widespread pests of agriculture. Key to the success of these insects, both in their native ranges and as they expand into new areas, are their broad range of host plants (including grains, vegetables, legumes, and fruits) and ability to withstand a wide range of conditions, greatly increasing the likelihood that an invasive population of stink bugs moving into a new area will find a suitable habitat.

Though the damage inflicted by stink bugs varies by species, these pests share a common mode of feeding. They are equipped with needle-like piercing-sucking mouthparts consisting of interlocking mandibular and maxillary stylets. To feed, the insect inserts the stylet bundle into the tissue of a suitable plant-stems, leaves, and/or seeds—and injects digestive enzymes. These enzymes break down the plant tissues into nutritive fluids, which are then drawn out and ingested by the stink bug. The plant sustains mechanical and physiological damage from this feeding activity, and in some cases, the salivary secretions themselves may have toxic effects. Wounds inflicted by stink bugs are also vulnerable to secondary infections, and some species have been shown to act as vectors for plant pathogens.

Brown marmorated stink bug, Halyomorpha halys is one of the most significant invasive pests in the world, equipped with a high dispersal capacity, high reproductive potential, and a broad host range. Native to Asia, H. halys has expanded its global range into the Americas and Europe. H. halys was first detected in the US near Allentown, Pennsylvania in the 1990s, and has since spread to 40 states and the District of Columbia. This species is extremely polyphagous, with estimates of its host range ranging from ˜100 plant species to >300, including fruit crops (apple, cherry, citrus, grape, peach, pear, raspberry), row crops (corn, soybean), vegetables (eggplant, pepper, okra, tomato), forest trees (maple, willow) and ornamentals (honeysuckle, lilac, Hibiscus). H. halys is a particularly threatening pest in orchard crops, where it tends to quickly displace seasonal native stink bugs to become the dominant stink bug present, capable of damaging crops year-round. Among field crops, H. halys predominately affects corn, discoloring kernels and decreasing their size; and soybean, resulting in shriveled seeds, flattened pods, and reduced soybean quality.

In 2010, H. halys populations spiked in the mid-Atlantic US, causing severe losses in several crops, including apple, peach, pepper, corn, and soybean. Losses to mid-Atlantic apple growers alone were estimated to exceed $37 million, while New Jersey peach growers saw losses of 60-90% of their crop. Total (100%) peach crop losses were reported in Maryland. Additional crop damage was reported across the mid-Atlantic in 2011, though not as serious as in the previous year, likely due to a quadrupling of pesticide applications in some Maryland and West Virginia orchards. Such drastic increases in pesticide use have disrupted integrated pest management (IPM) programs in stone and pome fruit orchards in the eastern US. H. halys has also been found damaging small fruits and hazelnuts in Oregon and Washington.

Neotropical brown stink bug, Euschistus heros, is endemic to the Neotropics but until recently was rarely reported on crops. Changes to farming practices in this region, including increased cultivation of soybean and adoption of multiple cropping and no-tillage cultivation since the 1980s, created prime conditions for E. heros populations to thrive by providing an ample year-round food supply and increasing the number of generations they can complete per year. It is now considered a potential invader into the US, a substantial risk considering the frequency of trade between the US and neotropical nations, which has also increased in recent decades. While E. heros shows a preference for soybean, where its feeding can reduce both seed quality and crop yield, this pest also feeds on 20 other plant species in 10 families, favoring Fabaceae, Asteraceae, Brassicaceae, and Solanaceae. It has also been recently reported on cotton, a member of the Malvaceae family. Attacks by E. heros on cotton can significantly reduce seed cotton yield in transgenic and conventional bolls, as well as causing lint stains, feeding punctures, and warty growths. Seed cotton and fiber production and micronaire quality (an indication of fiber fineness and maturity) have all been found to decrease linearly as infestation rate of E. heros increases, with up to 60% reduction reported in seed cotton and lint production.

Brown stink bug, Euschistus servus, is widespread across Eastern North America. E. servus was once considered a sporadic pest of cultivated crops, but increased adoption of no-till practices, decreased use of broad-spectrum pesticides, and adoption of transgenic cotton, which eliminated competition from heliothine larvae, facilitated the rise of E. servus as an impactful pest of agriculture in the Southeastern US. In corn, E. servus attacks the crop throughout its growth, but the most vulnerable period is the interval between emergence (VE) and the V6 stage, ˜3 weeks after planting. E. heros feeding can lead to ‘window-pane’ injuries to the leaves, decrease plant vigor, stunted crop growth, and in severe cases, even the death of the plant. The broad range of crops E. servus is known to feed on makes this pest particularly challenging to control. If forced out of one host, the pest's strong flight capacity allows it to easily migrate into susceptible plants nearby, including legumes, shrubs, weeds, and cultivated crops such as cotton, okra, peas, peach, sorghum, soybean, tomato, and wheat.

Redbanded Stink Bug, Piezodorus guildinii, is one of the most impactful pests of soybean in the New World. First recognized in the Caribbean, P. guildinii is currently found from Argentina to the American South and as far west as New Mexico. It has been reported as the primary stink bug pest of soybean in Brazil since the 1970s, when a revolution in agricultural technology and land use precipitated ecosystem changes that correlated with a shift in dominance from Nezara viridula, the Southern green stink bug, to P. guildinii as the key stink bug species on soybean. E. heros has since become the most abundant stink bug in Brazilian soybean fields, but P. guildinii still inflicts greater economic damage to the crop when they occur in large numbers. Similarly, while P. guildinii has been established in the US at least since the 1960s, it has only emerged as a major pest of soybean since 2002, when populations began to expand in soybean- and cotton-growing regions of Louisiana and Texas. P. guildinii is now the most yield-limiting pest of Louisiana soybean crops and a major pest in the upper Gulf Coast region of Texas, Alabama, Georgia, Mississippi, and South Carolina. From 2003 to 2009, a survey found that stink bugs infested ˜80% of soybean acreage in Arkansas, Louisiana, Mississippi, and Tennessee, destroying 126 tons of soybean in 2009. P. guildiniii has been reported feeding on >45 plant species in 22 families, including several important food crops such as alfalfa, common bean, lentil, and pea.

Southern Green Stink Bug, Nezara viridula, is one of the most polyphagous stink bug species, feeding on 145 plant species. N. viridula's habitat ranges across tropical and subtropical regions of Asia, Africa, the Americas, and Europe. In the US, N. viridula is largely restricted to the Southeast, from Florida and Virginia to Ohio, Arkansas, and Texas, but it is also established in Hawaii and California, producing as many as four generations a year in warmer climates. Unless effective control measures are implemented, N. viridula can inflict substantial harm on a wide range of fruit, vegetable, and row crops, including soybean, pecan, macadamia, and bean. Extraction of plant nutrients by stink bug feeding retards plant growth, reduces seed weight and number, and can lead to premature fruit drop, while the blemishes, discolorations, and malformations induced by this activity reduce crop quality and salability. Georgia growers suffer ˜$13 million in losses to this pest each year. N. viridula also transmits pathogenic Nematospora spp., which can rot the interior of beans, cotton, tomato, soybean, and citrus.

In addition to the agricultural damage inflicted by stink bugs, one of the species described above, H. halys, is also a major nuisance pest due to its unique overwintering behavior. Unlike other pentatomids, which overwinter in natural shelters, H. halys tends to seek out shelter inside human-made structures (attics, garages, vehicles, etc.), infesting walls, insulation, wood piles, and other cool, dry spaces, often in high numbers. In 2011, one Maryland homeowner collected 26,205 H. halys insects in the home in just 6 months. As the weather warms, the insects may become more active, often moving into human living areas to the dismay of their unwittting human roommates. Though H. halys are not known to transmit disease and do not bite or sting humans, they discharge a long-lasting disagreeable odor when disturbed, and can cause staining of floors, walls, and other surfaces with their excrement.

Several methods of control have been developed and implemented against stink bugs. Monitoring techniques are the first line of defense against these pests, particularly in areas at risk of invasion by non-native species. Common monitoring tools include sweep nets, beating samples, black light traps, and pheromone-baited traps. Establishing an accurate and appropriate threshold for stink bug detection using these techniques can be challenging, as the impacts of these pests on plant health may vary by crop type and growth stage. Physical monitoring methods may fail to detect all stink bugs in a given field, as the insects often drop to the ground or fly off when disturbed by the movement of the net or sample cloth. Pheromone and black light traps may provide a more sensitive means of detection, as well as information on the abundance, distribution, and flight activity of stink bug species present.

The most common method of stink bug control is the use of conventional pesticides, such as carbamates, pyrethroids, neonicotinoids, organophosphates, and the organochlorine endosulfan. Use of broad-spectrum insecticides is often quite heavy. In Brazil, for example, ˜5 million tons of pesticides are applied to control stink bugs every year. Together with the velvetbean caterpillar, Anticarsia gemmatalis, the stink bug pest complex is the target >90% of insecticides applied in Brazil. Such heavy reliance on conventional broad-spectrum pesticides is a problematic and likely unsustainable method of stink bug control, for several reasons. First, several classes of insecticides have proven to have inconsistent efficacy across different stink bug species. During the 2010 H. halys outbreak, mid-Atlantic tree fruit growers lacked clear guidance on the selection of control measures for the invasive pest, so many of them chose to apply pesticides intended for control of native stink bugs, mostly pyrethroids. These chemicals largely failed to achieve effective crop protection from H. halys, showing extremely limited residual activity. Second, broad-spectrum pesticides tend to have harmful effects on a broad range of species other than the target pests. Conventional pesticide exposure has been linked to multiple human health problems, including neurological effects, respiratory, reproductive, and developmental disorders, and cancers. According to a 1992 EPA estimate, there are ˜300,000 cases of pesticide-related poisonings in the US every year. Similar negative health impacts have also been reported in multiple other nontarget organisms, including other mammals, birds, fish, amphibians, and beneficial insects, including pollinators and natural enemies.

The third critical weakness of conventional pesticides to control stink bug pests is their vulnerability to resistance. Insects are continually adapting to changes in their environment, responding to different pressures in ways that increase their chances of survival. Pesticide applications act as a strong selective pressure on insect populations, so that if growers do not take care to rotate chemicals with different modes of action, they can inadvertently drive resistance to even the most effective pesticides. Several stink bug pests have developed resistance to one or more chemical classes used to control them. Before endosulfan was banned in 2013, multiple failures were reported in its use to control E. heros in Brazil, after it had been used against the pest for nearly half a century. E. heros has also shown reduced susceptibility to organophosphates, and to a lesser degree, to pyrethroids and neonicotinoids. Crop losses to stink bug pests unfortunately often prompt affected growers to increase applications of the same insecticides they have used in the past-growers initially responded to the first failures of endosulfan to control E. heros by increasing their use of endosulfan to 2.5 times the recommended concentration-which may serve to worsen resistance problems rather than correcting them.

In light of the shortcomings of chemical-based control measures, research is underway to identify alternative management tools, including biological control, development of resistant crop strains, and RNA interference. Research continues on which parasitoids are most effective against various stink bug species. Though new stink bug-resistant varieties of some crops are under development and have shown some positive results, most have shown limited commercial viability because they lack the characteristics farmers demand (high yield, stability, and resistance to nematodes, diseases, and lepidopteran pests). RNA interference (RNAi), a technique that uses a natural mechanism of gene regulation to interfere with the growth or survival of target insect species, has been evaluated against several pests, including E. heros. It was reported in 2020 that E. heros suffered 35% mortality 4 days after RNAi treatment, along with a significant reduction in the expression of the targeted gene. Though this finding suggests the potential of RNAi as a more targeted means of stink bug control than conventional pesticides, further study is needed to demonstrate its efficacy under field conditions, as well as against additional pest species.

As the shortcomings associated with conventional pesticides have become clearer, certain sectors of agriculture have turned to an alternative means of pest control: the use of insect semiochemicals (behavior-modifying chemicals) to protect crops by a variety of means, such as reducing their rate of reproduction (through mating disruption), driving them away from susceptible plants (repellency), or drawing them to a trap or a source of insecticide to remove them from the field [mass trapping or attract-and-kill (A&K)].

Semiochemical-based pest control holds many advantages over traditional pesticides. Most semiochemicals are short-lived and nature-identical, without adverse effects on human health. They also tend to be more specific in their activity, not affecting non-targets such as pollinators and natural enemies. Semiochemical strategies can be used to suppress pest populations in the field with drastically reduced inputs of chemical pesticides, as with A&K, or with no pesticide use at all, as with mating disruption. Semiochemical control strategies have also been shown to be less susceptible to resistance than traditional pesticides. There has only been one reported case of resistance to a semiochemical pesticide, in an attempt to manage tea tortrix, Adoxophyes honmai, which was later found to be the result of the use of an incomplete pheromone blend; this resistance was reversed by deploying the complete pheromone blend.

Despite these advantages, semiochemical-based technologies have gained only limited commercial success, largely due to the difference in cost between these strategies and most conventional pesticide applications. Pheromones and other semiochemical AIs are typically more expensive to produce than chemical pesticides ($1,000-3,500/kg), and because semiochemicals are generally short-lived, they require the use of a controlled-release mechanism to sustain their activity long enough to achieve effective pest control. Most semiochemical products developed to date are device-type dispensers, such as rubber septa and bubble caps, which must be placed by hand, often at high densities, increasing application costs. For this reason, semiochemical-based pest control strategies have largely been relegated to high-value crops or to situations where conventional pesticides cannot be used, such as the management of forestry pests.

Stink bugs are a prime example of a pest group that has been considered unsuitable for semiochemical-based control methods, as they often have overlapping host and geographic ranges and feed on a broad range of row crops, which are characterized by relatively low-value commodities cultivated over large areas, exacerbating the cost issues that have prevented broader adoption of semiochemical control by growers.

Nevertheless, several semiochemical-based techniques have been tested against various stink bug pests. Possibly the most common is the use of pheromones as lures for monitoring traps, which have been used inform management decisions against green stink bug in multiple fruit and nut crops, relying on an aggregation pheromone blend comprising a 95:5 combination of (4S)-cis-Z-bisabolene epoxide and (4S)-trans-Z-bisabolene epoxide. Traps baited with the pheromone of the brown-winged green bug, Plautia stali, methyl (2E,4E,6Z)-decatrienoate (MDT), have proven attractive to adult and nymphal H. halys in the US, though adults are only attracted by MDT at later stages of the growing season. An aggregation pheromone produced by H. halys males has also been identified, comprising two components: (3S,6S,7R,10S)-10,11-epoxy-1-bisabolen-3-ol and (3R,6S,7R,10S)-10,11-epoxy-1-bisabolen-3-ol at a 3.5:1 ratio. Unlike MDT, this aggregation pheromone is attractive to H. halys nymphs and adults season-long, and a synergistic effect has been reported on both life stages when both pheromones are deployed together. Both semiochemicals have been used to inform H. halys management decisions in apple orchards, reducing pesticide applications by >40%.

Sex pheromones and aggregation pheromones have also been tested in strategies for stink bug pest control, through mass trapping, trap cropping, and A&K. In one study, traps baited with the pheromone of E. servus were placed at borders dividing peanut and cotton plots in two field experiments, to determine their capacity to prevent dispersal of the pest. The traps failed to inhibit the spread of E. servus once the cotton crop began to produce fruit, suggesting that such a measure would be an inadequate standalone method of protection for cotton. Conversely, soybean trap crops complemented with pheromone traps significantly reduced E. servus density in cotton crops compared to control plots. This finding has been interpreted as an indication that E. servus may require a preferred food source to stay in a location they have been drawn to via semiochemical attraction. An experiment performed by citizen scientist volunteers illuminated an additional challenge in implementing a semiochemical mass trapping program: the risk of spillover. When MDT-baited traps were placed at the row ends of small tomato plots in an attempt to reduce damage by H. halys, the treatment had the opposite effect. Fruit damage was significantly more severe in plots where the traps were placed. This spillover effect has often been associated with traps baited with aggregation pheromones, as insects are drawn into the vicinity of the trap by the lure inside, but do not actually enter it, instead feeding on the host plants nearby. A combination of aggregation pheromone and MDT has also been assessed as part of a toxic bait targeting H. halys, in which the pheromone blend was applied to apple trees on the border of the plot area, to draw the pests away from the majority of the crop and kill them before they could inflict significant damage. Baited trees retained H. halys longer than unbaited trees (˜24 h vs. ˜3 hr) and killed significantly more H. halys adults. Baited trees also suffered a significantly higher rate of fruit injury than adjacent unbaited trees, an indication that the creation of A&K trap crop zones around the borders of orchard crops could be an effective strategy to reduce overall crop damage, while also reducing the quantity of insecticide applied over the field. Such a strategy has yet to be evaluated in other crops attacked by H. halys.

As such, there is a need for alternative methods of controlling stink bug pests that improves significantly upon the efficacy of available pesticides, targeting multiple pest species while drastically reducing the risk of negative non-target and environmental effects and the development of resistance.

### BRIEF SUMMARY

In accordance with one embodiment of the present disclosure, there is contemplated a method of controlling a hemiptera population in a region. The method includes administering a composition having at least one aggregation pheromone and at least one kairomone attractant to the region.

The composition may further include at least one pesticide. In certain embodiments, the pesticide may be present in the composition in a range of approximately 0.1% to approximately 2%. In particular, the pesticide may be present in the composition in an amount of about 2%. The pesticide may be a pyrethroid insecticide. While it is not intended to be limited to the following, the pesticide may be bifenthrin, thiamethoxam, λ-cyhalothrin, ethiprole, imidacloprid, cypermethrin, fipronil, blends thereof, or any suitable pesticide.

Notably, the composition may be rainfast and retains its efficacy for at least 24 hours. In certain embodiments the composition may retain its efficacy for at least 3 weeks.

The composition may be administered to the region at a volume range of approximately 0.5 L/ha to approximately 1.0 L/ha.

In certain embodiments, the aggregation pheromone may be attractive to stink bug adults of both sexes and/or to stink bug nymphs. In some embodiments, the at least one kairomone attractant is a blend of two or more kairomone attractants.

Another embodiment of the present disclosure contemplates a composition for controlling a hemiptera population comprising at least one aggregation pheromone and at least one kairomone attractant. The composition may further include at least one pesticide.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present disclosure proposes an A&K strategy combining two classes of attractants to maximize its potency and its range of target pests: an aggregation pheromone common in various species of pentatomids; and a blend of plant-produced kairomones. The aggregation pheromone is attractive to stink bug adults of both sexes, as well as to nymphs—critical advantages over mating disruption and other adult-specific techniques, as stink bug nymphs can be just as damaging as adults. Plant-produced kairomones (semiochemicals released by one species and responded to by another, as opposed to pheromones, which are produced and responded to by members of the same species) play many roles in influencing insect behavior, including selection of host plants among non-hosts, assessment of suitability of a plant for feeding or oviposition, and initiation or termination of aggregation behaviors. The kairomones, commonly found in multiple plant species, were first identified as potential stink bug attractants as constituents in another A&K formulation being developed to target noctuid moth pests. During field testing of this product, large numbers of stink bugs were found among the bycatch, which led to testing the blend specifically against stink bugs, with the aggregation pheromone added to enhance its potency.

These pheromone and kairomone attractants will be combined with an effective reduced-risk killing agent, for example, bifenthrin. Bifenthrin is a pyrethroid insecticide, synthetic versions of pyrethrins, insecticidal agents derived from chrysanthemum flowers. It has been approved by the US EPA for use on multiple agricultural crops and even inside homes. These three active components (aggregation pheromone, kairomone blend, and bifenthrin) will be incorporated into a controlled-release matrix, SPLAT, a food-grade wax emulsion that becomes less viscous under agitation, such as by stirring or vibration, allowing it to be applied through a wide variety of manual and mechanized technologies. SPLAT© (Specialized Pheromone and Lure Application Technology) is described in U.S. Pat. No. 7,887,828, the entirety of which is incorporated by reference herein. This matrix is comprised entirely of food-safe, organic inert ingredients, adheres quickly and effectively to a wide variety of substrates including plant bark and foliage, and has demonstrated a consistent ability to release a broad range of attractants, repellents, phagostimulants, and other behavior modifying chemicals (also known as semiochemicals) at biologically active release rates, enabling season-long control for many insect pests. SPLAT products developed to date have targeted a broad range of insect pests of agriculture and forestry, including moths, beetles, hemipterans, and dipterans, as well as arthropod vectors of disease; sustaining the release of their incorporated AIs at biologically active rates for 2 weeks up to 6 months. Point sources of the presently disclosed compositions, applied in the field as discrete point sources rather than as a ubiquitous cover spray, as with traditional pesticides, will quickly cure and become rainfast, slowly releasing the incorporated attractants over a period of 3-4 weeks. Attractive scent plumes released by these point sources will draw multiple species of adult and nymphal stink bugs to the bait and induce them interact with it, contaminating themselves with a lethal dose of bifenthrin. This intensified exposure will greatly increase the mortality rate of the insects exposed to it, increasing the effectiveness of the application and reducing the likelihood that resistance will develop among the target population.

Additional advantages of the compositions of the present disclosure include reduced insecticide inputs—an application of the compositions will use only a small fraction of the pesticide AI that would be required for a traditional cover spray—while improving crop yield and quality; reduced impacts on nontarget species due to the inclusion of stink bug-specific attractants and a reduced-risk insecticide; amenability to rapid mechanized application, unlike most semiochemical pest control products, which require manual application; ability to target both nymphs and adult stink bugs of multiple species; and extended field life.

One aspect of the present disclosure is a composition containing a blend of aggregation pheromone and plant-produced kairomone attractants with a small quantity of a reduced-risk insecticide in a flowable wax-based matrix designed for controlled release of insect semiochemicals (behavior-modifying chemicals), SPLAT (Specialized Pheromone & Lure Application Technology). This encapsulation will ensure that the composition will maintain its efficacy in the field for 3-4 weeks, luring stink bug adults and nymphs across distances to point sources of the composition, inducing them to interact with the insecticide-laced material. This intensified exposure makes it far less likely that the insects will survive the initial application, therefore less likely that a resistant population will arise. The result is a safe, inexpensive, and long-lasting control solution for multiple native and invasive stink bug pests. The commercial market for such a product is vast, due to the extremely broad range of economically important crops damaged by stink bug infestations, both within the US and abroad, including row crops, fruits, vegetables, and ornamental plants. Organic growers will likely be particularly eager to adopt its use, due to the current lack of viable alternatives to conventional insecticides, which cannot be applied in organic crops. Homeowners and home gardeners attempting to deal with stink bug infestations represent an additional commercial market for the product, which will allow these end users to suppress populations of these pests in and around their property using only a fraction of the pesticide that would be required for a traditional application.

The compositions described herein are an effective, sustainable control product for stink bugs, a pest group with widespread impacts on agriculture. The compositions deliver effective stink bug control in multiple crops with only a fraction of the pesticide used in traditional cover sprays. Inclusion of a blend of pheromone and kairomone attractants draw stink bug adults and nymphs of multiple species to point sources of the product across distances, substantially reducing the amount of material that will need to be applied to achieve adequate coverage of a crop field, and also induce the target insects to interact with the product, intensifying their exposure to an incorporated reduced-risk pesticide, ensuring rapid mortality. Encapsulation of the attractants and killing agent in a controlled-release matrix, SPLAT (Specialized Pheromone & Lure Application Technology), ensures that this attract-and-kill (A&K) product remains effective for 3-4 weeks, providing protection for crops with far fewer applications required than with conventional pesticides. By improving control of a pervasive, highly damaging group of insects-reducing damage in a wide range of important food and commodity crops—with reduced reliance on toxic chemical pesticides, this product addresses several needs of agricultural producers and provides private consumers with a means to deal with nuisance infestations of H. halys in their homes, cars, or gardens.

A liquid composition is disclosed which when mixed with certain insecticides induces insect, more specifically hemiptera, to respond by attraction, manipulation and phagostimulation of the formulation which causes the insects to have reduced reproductive viability, including death. The composition retains its effect and activity after field application to susceptible founa under normal ambient conditions, maintaining attraction and insecticidal effect for a period of at least twenty-four hours by combining the adjuvant with a specific insecticide. The combination of the adjuvant and the insecticide composition upon application to the field, or vegetation, has the unexpected property of retaining its attraction, phagostimulation and toxic activity throughout the maximum residence time necessary for effective pest control by virtue of the fact that the composition resists being washed by humidity, protecting both insecticide and attractants and phagostimulants, while still allowing insects to feed on, and manipulate, the resulting treatment.

Initial work on products of the present disclosure consisted of combining the aggregation pheromone and plant-produced kairomone attractants blended with a carbamate pesticide, methomyl, to suppress E. heros populations and crop damage. Since then, the reduced-risk pesticide, bifenthrin, has been utilized. The present disclosure provides one of the first demonstrations of the feasibility of a semiochemical-based technology for pest control for use in row crops, as well as fruit and vegetable crops. Because the product requires only a small percentage of the pesticide used in cover sprays, its use will reduce crop contamination and risks to farm workers, consumers, and the environment.

The product will be applied at 1.0 L/ha, versus 2.5 L/ha for ultra-low volume pesticides and up to 200 L/ha for conventional pesticides. Because it attracts pests to a killing agent, it does not need to be applied as a blanket spray over the entire area, but instead as a series of discrete point sources covering <5% of the crop. Unlike conventional pesticides, which are dispersed as a mist susceptible to spray drift, it contains only 2% pesticide and is deposited on the surface of the crop as small dollops of 50-100 mg, unsusceptible to crosswind drift.

The presently discloses compositions provide multiple advantages over conventional pesticides, including reduced threats of resistance due to its capacity to induce intensified exposure through the inclusion of pheromone and kairomone attractants, longer-lasting efficacy, and drastically reduced pesticide inputs, resulting in higher quality crops and reduced risks to workers, consumers, and the environment.

This composition combines a blend of aggregation pheromone and plant-produced kairomone attractants with a small quantity of a reduced-risk insecticide. This composition is a novel alternative method of insect control. The novelty comes from the functional technical features of the composition and how they work together. The novel composition provides both an efficacious and environmentally friendly control technology for stink bug pests of agriculture. The composition is rainfast, retaining its effect and activity after application maintaining attraction and insecticidal effect for (at least 24 hours).

The composition is a field-worthy attract-and-kill (A&K) formulation that provides effective, long-lasting control of hemiptera pests with added technical, economic, and social benefits. The claims and benefits include: increased efficacy in comparison to conventional insecticide application at labeled rate; increased mortality rate of the pest due to topical contact and ingestion by the pest; rain fastness—longevity of insecticidal activity in comparison to conventional insecticide application at labeled rate; reduced insecticide used, about 2% of conventional application at labeled rate; reduction of potential health effects due to reduction in insecticide; reduction of environmental toxicity due to reduction in insecticide; reduction in water used; reduction in application time and fuel/energy use; reduction in grower cost; reduction in beneficial and non-target insect impact; reduction in insect resistance potential (point source of lethal dose & ability to rotate with different insecticides with different modes of action); and reduction of insecticide drift potential (formulation holding reduced insecticide from rapid volatilization).

Broad-spectrum pesticides are the most common method of control for stink bug pests in agriculture, but this approach has been shown to have major shortcomings. The toxic mode of action of most of these chemicals makes them a threat to human health as well as to other nontarget species, especially beneficial insects such as honeybees and other pollinators. Conventional insecticides have also repeatedly proven susceptible to the development of resistance, the gradual buildup of tolerance to a given chemical in a target pest population, eventually resulting in its loss of efficacy as a control agent.

This composition provides an alternative control method for stink bug pests that significantly improves upon the efficacy of available conventional pesticides, targeting multiple pest species while drastically reducing the risk of negative non-target and environmental effects and the development of resistance. This composition combines a blend of aggregation pheromone and plant-produced kairomone attractants with a small quantity of a reduced-risk insecticide in a flowable wax-based matrix designed for controlled release of insect semiochemicals (behavior-modifying chemicals), SPLAT (Specialized Pheromone & Lure Application Technology). This encapsulation ensures that this composition will maintain its efficacy in the field for 3-4 weeks, luring stink bug adults and nymphs across distances to point sources of this composition, inducing them to interact with the insecticide-laced material. This intensified exposure makes it far less likely that the insects will survive the initial application, therefore less likely that a resistant population will arise.

This composition provides a safe, inexpensive, and long-lasting control solution for multiple native and invasive stink bug pests. The commercial market for such a product is vast, due to the extremely broad range of economically important crops damaged by stink bug infestations, both within the US and abroad, including row crops, fruits, vegetables, and ornamental plants. Homeowners and home gardeners attempting to deal with stink bug infestations represent an additional commercial market for this composition, which will allow these end users to suppress populations of these pests in and around their property using only a fraction of the pesticide that would be required for a traditional application.

This composition delivers effective stink bug control in multiple crops with only a fraction of the pesticide used in traditional cover sprays. Inclusion of a blend of pheromone and kairomone attractants draws stink bug adults and nymphs of multiple species to point sources of this composition across distances, substantially reducing the amount of material that will need to be applied to achieve adequate coverage of a crop field, and also induces the target insects to interact with the product, intensifying their exposure to an incorporated reduced-risk pesticide, ensuring rapid mortality. Encapsulation of the attractants and killing agent in a controlled-release matrix, SPLAT (Specialized Pheromone & Lure Application Technology), ensures that this attract-and-kill (A&K) product remains effective for 3-4 weeks, providing protection for crops with far fewer applications required than with conventional pesticides.

This composition results in a long-lasting A&K product for stink bugs. This composition combines two classes of attractants to maximize its potency and its range of target pests: an aggregation pheromone common in various species of pentatomids; and a blend of plant-produced kairomones. The aggregation pheromone is attractive to stink bug adults of both sexes, as well as to nymphs-critical advantages over mating disruption and other adult-specific techniques, as stink bug nymphs can be just as damaging as adults. Plant-produced kairomones (semiochemicals released by one species and responded to by another, as opposed to pheromones, which are produced and responded to by members of the same species) play many roles in influencing insect behavior, including selection of host plants among non-hosts, assessment of suitability of a plant for feeding or oviposition, and initiation or termination of aggregation behaviors. The kairomones in this composition, commonly found in multiple plant species, were first identified as potential stink bug attractants as constituents in another A&K formulation being developed designed to target noctuid moth pests. During field testing of this product, large numbers of stink bugs were found among the bycatch, which led to testing the blend specifically against stink bugs, with the aggregation pheromone added to enhance its potency.

In the US, these pheromone and kairomone attractants will be combined with an effective reduced risk killing agent, for example, bifenthrin. Bifenthrin is a pyrethroid insecticide, synthetic versions of pyrethrins, insecticidal agents derived from chrysanthemum flowers. It has been approved by the US EPA for use on multiple agricultural crops and even inside homes. These three active components (aggregation pheromone, kairomone blend, and bifenthrin) will be incorporated into SPLAT, a food-grade wax emulsion that becomes less viscous under agitation, such as by stirring or vibration, allowing it to be applied through a wide variety of manual and mechanized technologies. SPLAT products developed to date have targeted a broad range of insect pests of agriculture and forestry, including moths, beetles, hemipterans, and dipterans, as well as arthropod vectors of disease; sustaining the release of their incorporated AIs at biologically active rates for 2 weeks up to 6 months. Point sources of this composition, applied in the field as discrete point sources rather than as a ubiquitous cover spray, as with traditional pesticides, will quickly cure and become rainfast, slowly releasing the incorporated attractants over a period of 3-4 weeks.

The desired pesticide may be present in the formulation in a range from approximately 0.1% to approximately 2%. While many pesticides may be used, depending on the preference, and even multiple pesticides at once, examples of pesticides that may be used with the present formulations include, but are not limited to, thiamethoxam, λ-cyhalothrin, ethiprole, imidacloprid, cypermethrin, fipronil, and bifenthrin.

Attractive scent plumes released by these point sources draw multiple species of adult and nymphal stink bugs to the bait and induce them interact with it, contaminating themselves with a lethal dose of bifenthrin. This intensified exposure will greatly increase the mortality rate of the insects exposed to it, increasing the effectiveness of the application, and reducing the likelihood that resistance will develop among the target population. Additional advantages of this composition include reduced insecticide inputs—an application of this composition will use only a small fraction of the pesticide AI that would be required for a traditional cover spray—while improving crop yield and quality; reduced impacts on nontarget species due to the inclusion of stink bug-specific attractants and a reduced-risk insecticide; amenability to rapid mechanized application, unlike most semiochemical pest control products, which require manual application; ability to target both nymphs and adult stink bugs of multiple species; and extended field life.

The above description is given by way of example, and not limitation. Given the above disclosure, one skilled in the art could devise variations that are within the scope and spirit of the invention disclosed herein, including various ways of dispersing the compositions. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of controlling a hemiptera population in a region, the method comprising administering a composition comprising at least one aggregation pheromone and at least one kairomone attractant to the region.

2. The method of claim 1, further comprising at least one pesticide.

3. The method of claim 2, wherein the at least one pesticide is present in the composition in a range of approximately 0.1% to approximately 2%.

4. The method of claim 8, wherein the at least one pesticide is present in the composition in an amount of about 2%.

5. The method of claim 1, wherein the composition is rainfast and retains its efficacy for at least 24 hours.

6. The method of claim 1, wherein the composition retains its efficacy for at least 3 weeks.

7. The method of claim 1, wherein the composition is administered to the region at a volume range of approximately 0.5 L/ha to approximately 1.0 L/ha.

8. The method of claim 2, wherein the at least one pesticide is a pyrethroid insecticide.

9. The method of claim 8, wherein the at least one pesticide is bifenthrin.

10. The method of claim 2, wherein the at least one pesticide is thiamethoxam.

11. The method of claim 2, wherein the at least one pesticide is λ-cyhalothrin.

12. The method of claim 2, wherein the at least one pesticide is ethiprole.

13. The method of claim 2, wherein the at least one pesticide is imidacloprid.

14. The method of claim 2, wherein the at least one pesticide is cypermethrin.

15. The method of claim 2, wherein the at least one pesticide is fipronil.

16. The method of claim 1, wherein the aggregation pheromone is attractive to stink bug adults of both sexes.

17. The method of claim 1, wherein the aggregation pheromone is attractive to stink bug nymphs.

18. The method of claim 1, wherein the at least one kairomone attractant is a blend of two or more kairomone attractants.

19. A composition for controlling a hemiptera population comprising at least one at least one aggregation pheromone and at least one kairomone attractant.

20. The composition of claim 19, further comprising at least one pesticide.
